(19) United States
(12) Patent Application Publication
(10) Pub. No.: US 2026/0203947 A1
(43) Pub. Date: Jul. 16, 2026

(54) OXYGEN LEVEL MONITORING METHOD, OXYGEN LEVEL MONITORING APPARATUS, AND WELDING SYSTEM

(71) Applicant: Prime Planet Energy & Solutions, Inc., Tokyo (JP)

(72) Inventors: Kazuki TAMURA, Takasago-shi (JP); Kohei MATSUBARA, Kasai-shi (JP)

(21) Appl. No.: 19/432,879

(22) Filed: Dec. 24, 2025

(30) Foreign Application Priority Data
Jan. 10, 2025 (JP) 2025-003988

(51) Int. Cl. G06T 7/90; B23K 9/095; G06T 7/00

(52) U.S. Cl. CPC G06T 7/90; B23K 9/0956; G06T 7/0004; G06T 2207/10024; G06T 2207/20081; G06T 2207/30164; G06T 2207/30232

(57) ABSTRACT

An oxygen level monitoring method is a method for monitoring an oxygen level in a welding atmosphere during welding of a workpiece. The oxygen level monitoring method includes: a step of measuring a color of welding light produced during welding of the workpiece; and a step of determining whether the oxygen level in the welding atmosphere is less than or equal to a predetermined level in accordance with the measured color of the welding light.

### CROSS REFERENCE TO RELATED APPLICATIONS

This application claims the benefit of priority to Japanese Patent Application No. 2025-003988 filed on Jan. 10, 2025. The entire contents of this application are incorporated herein by reference.

### BACKGROUND

### 1. Field of the Invention

The present invention relates to oxygen level monitoring methods, oxygen level monitoring apparatuses, and welding systems.

### 2. Description of the Related Art

JP 2017-164803 A discloses a quality determining method for high-energy beam welding that involves performing welding by emitting a high-energy beam to a workpiece. The quality determining method detects shape information on a molten pool by subjecting a camera-captured image of the molten pool to image processing. The method involves detecting welding light sensor information including information on plasma light with a welding light sensor. The method involves obtaining a partial regression analysis coefficient by conducting a multiple regression analysis, where the penetration depth of the molten pool is a response variable, and the shape information and the welding light sensor information are explanatory variables. The method further involves obtaining a predicted value for the penetration depth of the molten pool in accordance with the shape information on the molten pool, the welding light sensor information, and the partial regression analysis coefficient. The method then compares the predicted value with a reference value, resulting in the determination of welding quality.

### SUMMARY

If oxygen is contained in a welding atmosphere during welding of a workpiece, welding quality may decline. Accordingly, the inventors contemplate monitoring an oxygen level in a welding atmosphere.

An oxygen level monitoring method disclosed herein is a method for monitoring an oxygen level in a welding atmosphere during welding of a workpiece. The oxygen level monitoring method includes: a step of measuring a color of welding light produced during welding of the workpiece; and a step of determining whether the oxygen level in the welding atmosphere is less than or equal to a predetermined level in accordance with the measured color of the welding light. This method facilitates monitoring of the oxygen level in the welding atmosphere.

### BRIEF DESCRIPTION OF THE DRAWINGS

FIG. 1 is a schematic diagram of a welding system according to a first embodiment of techniques disclosed herein.

FIG. 2 is a block diagram of the welding system.

FIG. 3 is a flow chart illustrating an exemplary oxygen level monitoring method according to the first embodiment.

FIG. 4 is a graph illustrating welding light RGB value measurement results obtained in an experimental example.

FIG. 5 is a graph illustrating R/B value calculation results obtained in the experimental example.

FIG. 6 is a block diagram of a welding system according to a second embodiment of techniques disclosed herein.

FIG. 7 is a flow chart illustrating an exemplary oxygen level monitoring method according to the second embodiment.

### DETAILED DESCRIPTION

Embodiments of techniques disclosed herein will be described below with reference to the drawings. The embodiments described herein are naturally not intended to limit the present invention in any way. Where appropriate, components and elements similar in function are identified by common reference signs and their description may be omitted to avoid redundancy.

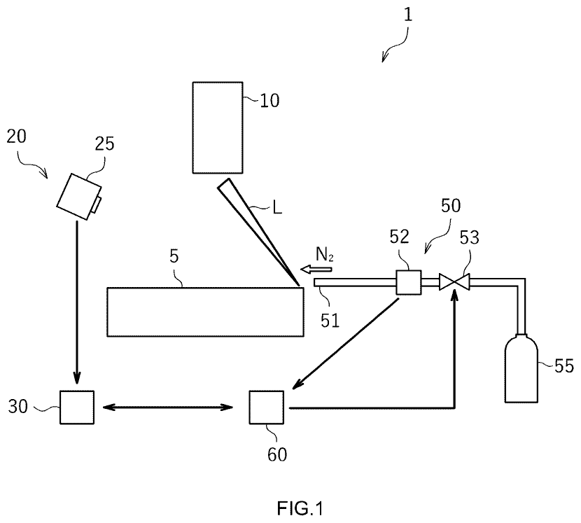

FIG. 1 is a schematic diagram of a welding system 1 according to a first embodiment of the techniques disclosed herein. The welding system 1 is used to weld a workpiece 5. As used herein, the term “workpiece” refers to any object that is to be welded. In one example, the welding system 1 may be used for manufacture of a lithium ion battery including a casing and a lid. In this case, the workpiece 5 may be the casing and the lid. The workpiece 5, however, may be any other suitable type of workpiece. The workpiece 5 may be made of any suitable material. Examples of materials for the workpiece 5 may include aluminum, an aluminum alloy, and a steel material. As illustrated in FIG. 1, the welding system 1 includes a welding apparatus 10.

The welding apparatus 10 welds the workpiece 5. The welding apparatus 10 may be of any suitable type. Any of various welding apparatuses known in the art may be used as the welding apparatus 10. In the mode illustrated in FIG. 1, the welding apparatus 10 is a “laser welding apparatus” that welds the workpiece 5 by emitting laser light L thereto. Although not illustrated, the welding apparatus 10 includes, for example, a laser oscillator and a scanner head.

If oxygen gas is contained in a welding atmosphere when the workpiece 5 is being welded by the welding apparatus 10, welding quality may decline. Accordingly, the inventors contemplate enabling welding of the workpiece 5 while monitoring an oxygen level in the welding atmosphere. As a result of careful examinations, the inventors have found a correlation between the color of welding light and the oxygen level in the welding atmosphere. The findings of the inventors suggest that the oxygen level is relatively low when the color of welding light is red, and the oxygen level is relatively high when the color of welding light is blue.

As used herein, the term “welding light” refers to light that is produced during welding of the workpiece 5. Examples of welding light include laser reflected light, thermal radiation light, and plasma light. The term “laser reflected light” refers to light that is produced by reflection of the laser light L (which is emitted from the welding apparatus 10) from the workpiece 5. The term “thermal radiation light” refers to light that radiates from the workpiece 5 owing to its thermal radiation. The term “plasma light” refers to light that radiates from plasma during welding of the workpiece 5.

The welding system 1 includes an oxygen level monitoring apparatus 20, an injection mechanism 50, and a control device 60. The oxygen level monitoring apparatus 20 monitors the oxygen level in the welding atmosphere during welding of the workpiece 5 in accordance with the color of welding light. The oxygen level monitoring apparatus 20 includes an image capturing device 25 and an image processing device 30.

The image capturing device 25 captures an image including welding light. The image capturing device 25 may capture a still image or may capture a moving image. In this embodiment, the image capturing device 25 captures a still image. The image capturing device 25 may be disposed at any suitable location that allows the image capturing device 25 to capture an image of welding light. In one example, the image capturing device 25 may be disposed above the workpiece 5.

The image processing device 30 is connected to the image capturing device 25 in a communicative manner. The image processing device 30 may be connected to the image capturing device 25 via a wired connection or a wireless connection. The image processing device 30 measures the color of welding light from the image captured by the image capturing device 25, thus determining whether the oxygen level in the welding atmosphere is less than or equal to a predetermined level. The image processing device 30 may be implemented by, for example, a computer including a communication interface, a storage, a memory, and a processor. The communication interface is an interface to transmit and receive data to and from other devices, such as the image capturing device 25 and the control device 60. The storage stores program(s) and data that are necessary when the processor carries out various processes. The memory serves as a working area for the processor.

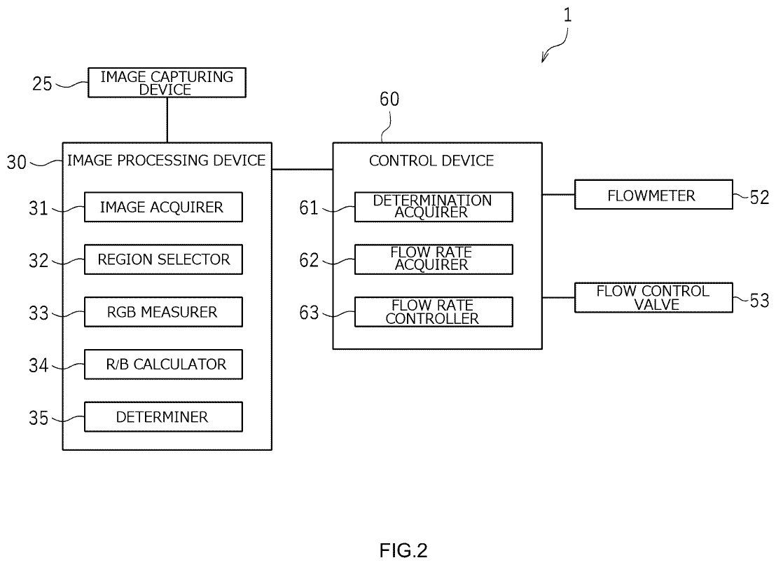

FIG. 2 is a block diagram of the welding system 1. The image processing device 30 includes an image acquirer 31, a region selector 32, an RGB measurer 33, an R/B calculator 34, and a determiner 35. The image acquirer 31 performs an image acquiring process. The region selector 32 performs a region selecting process. The RGB measurer 33 performs an RGB measuring process. The R/B calculator 34 performs an R/B calculating process. The determiner 35 performs a determining process. These processes will be described in detail below.

As illustrated in FIG. 1, the injection mechanism 50 blows inert gas onto the workpiece 5. In the mode illustrated in FIG. 1, an inert gas-containing cylinder 55 is connected to the injection mechanism 50. In this embodiment, nitrogen gas is used as inert gas. Instead of nitrogen gas, argon gas or helium gas, for example, may be used as inert gas. In the mode illustrated in FIG. 1, the injection mechanism 50 includes an injection nozzle 51, a flowmeter 52, and a flow control valve 53. Inert gas contained in the cylinder 55 is injected from the injection nozzle 51 and blown onto the workpiece 5. The flowmeter 52 measures a flow rate of inert gas to be blown onto the workpiece 5. The flow control valve 53 is a valve to adjust the flow rate of inert gas to be blown onto the workpiece 5. Any injection nozzle known in the art may be used as the injection nozzle 51. Any flowmeter known in the art may be used as the flowmeter 52. Any flow control valve known in the art may be used as the flow control valve 53.

The control device 60 is connected to the image processing device 30, the flowmeter 52, and the flow control valve 53 in a communicative manner. The control device 60 may be connected to each of the image processing device 30, the flowmeter 52, and the flow control valve 53 via a wired connection or a wireless connection. In accordance with the determination of the oxygen level in the welding atmosphere made by the image processing device 30, the control device 60 controls the flow rate of inert gas to be blown onto the workpiece 5 by the injection mechanism 50. The control device 60 may be implemented by, for example, a computer including a communication interface, a storage, a memory, and a processor. The communication interface is an interface to transmit and receive data to and from other devices, such as the image processing device 30, the flowmeter 52, and the flow control valve 53. The storage stores program(s) and data that are necessary when the processor carries out various processes. The memory serves as a working area for the processor. The image processing device 30 and the control device 60 may be combined into a single computer or may be separate computers.

As illustrated in FIG. 2, the control device 60 includes a determination acquirer 61, a flow rate acquirer 62, and a flow rate controller 63. The determination acquirer 61 acquires a result of the determining process performed by the image processing device 30. The flow rate acquirer 62 acquires a measurement result obtained by the flowmeter 52. The flow rate controller 63 controls an operation of the flow control valve 53, thus controlling the flow rate of inert gas to be blown onto the workpiece 5.

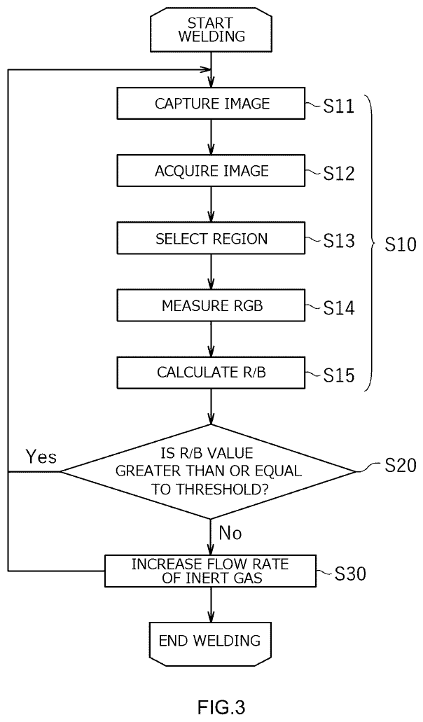

The following description discusses an oxygen level monitoring method to be performed by the welding system 1. FIG. 3 is a flow chart illustrating an example of the oxygen level monitoring method. The oxygen level monitoring method is a method for monitoring an oxygen level in a welding atmosphere during welding of a workpiece. The oxygen level monitoring method is performed during welding of the workpiece 5. As illustrated in FIG. 3, the oxygen level monitoring method includes: a step S10 of measuring the color of welding light; a step S20 of determining whether the oxygen level is less than or equal to the predetermined level; and a step S30 of increasing the flow rate of inert gas.

The step S10 of measuring the color of welding light involves measuring the color of welding light produced during welding of the workpiece 5. In this embodiment, the step S10 of measuring the color of welding light includes an image capturing step S11, an image acquiring step S12, a region selecting step S13, an RGB measuring step S14, and an R/B calculating step S15. The image capturing step S11 is performed by the image capturing device 25. The image acquiring step S12, the region selecting step S13, the RGB measuring step S14, and the R/B calculating step S15 are performed by the image processing device 30.

In the image capturing step S11, the image capturing device 25 captures an image including welding light. The image capturing step S11 may be performed at any suitable time. The image capturing step S11 may be performed at any desired time during welding of the workpiece 5. The image capturing step S11 is preferably performed at a predetermined time. In one example, the image capturing step S11 may be performed at one-second intervals from the start of welding to its completion. The image capturing step S11 involves capturing a color image.

The image acquiring step S12 involves performing the image acquiring process. The image acquiring process is a process of acquiring, from the image capturing device 25, the image captured by the image capturing device 25 in the image capturing step S11. In one example, the image acquiring process is performed by transmitting the image, which has been captured in the image capturing step S11, to the image processing device 30 from the image capturing device 25 through wireless communication.

The region selecting step S13 involves performing the region selecting process. The region selecting process is a process of selecting, under a predetermined condition, pixels representing welding light from the image captured in the image capturing step S11. Examples of the predetermined condition may include a time elapsed from the start of welding. When a path along which welding is to be performed by the welding apparatus 10 is set in advance, which position is being welded on the workpiece 5 is predictable in accordance with the time elapsed from the start of welding. Welding light radiates from the position being welded and its vicinity. Accordingly, gaining preliminary understanding of the relationship between the time elapsed from the start of welding and the pixels representing welding light allows suitable selection of the pixels, which represent welding light, from the image captured in the image capturing step S11. In this embodiment, the number of pixels selected in the region selecting step S13 is two or more. Alternatively, the number of pixels selected in the region selecting step S13 may be one.

The RGB measuring step S14 involves performing the RGB measuring process. The RGB measuring process is a process of measuring RGB values of the pixels selected in the region selecting step S13. As previously mentioned, the region selecting step S13 in this embodiment involves selecting two or more pixels. Accordingly, the RGB measuring step S14 in this embodiment involves calculating the averages of the RGB values of the pixels selected. In this embodiment, the values thus calculated are the measured RGB values of welding light.

As used herein, the term “RGB value” refers to a value represented by a combination of an R value, a G value, and a B value. A combination of an R value, a G value, and a B value enables representation of any color. An R value is indicative of a red component, a G value is indicative of a green component, and a B value is indicative of a blue component. An R value, a G value, and a B value are each represented, for example, in 256 levels from 0 to 255. For example, suppose that an R value, a G value, and a B value of welding light are measured in the RGB measuring step S14, and the R value is sufficiently greater than each of the G and B values. In this case, the color of welding light is reddish.

The R/B calculating step S15 involves performing the R/B calculating process. The R/calculating process is a process of calculating an R/B value from each RGB value of welding light measured in the RGB measuring step S14. The R/B value is the ratio of an R value to a B value and is calculated by division of the R value by the B value.

The step S20 of determining whether the oxygen level is less than or equal to the predetermined level is performed by the image processing device 30. The step S20 involves performing the determining process. The determining process is a process of determining whether the oxygen level in the welding atmosphere is less than or equal to the predetermined level in accordance with the color of welding light measured in the step S10. In other words, the determining process involves determining whether the oxygen level in the welding atmosphere is less than or equal to the predetermined level in accordance with the RGB value measured in the step S10. In this embodiment, the step S20 involves determining whether the R/B value calculated in the R/B calculating step S15 is greater than or equal to a predetermined threshold, thus determining whether the oxygen level in the welding atmosphere is less than or equal to the predetermined level. The findings of the inventors indicate that setting the predetermined threshold at “1.5”, for example, enables determining whether the oxygen level in the welding atmosphere is less than or equal to 3%. For example, when the R/B value calculated is 2.0, the oxygen level in the welding atmosphere is determined to be less than or equal to 3% in the step S20. When the R/B value calculated is 0.5, the oxygen level in the welding atmosphere is determined to be greater than 3% in the step S20. The threshold set in this embodiment, however, is not limited to “1.5”. In one example, the threshold may suitably be set in the range of 0.3 to 2.0. The predetermined level may be appropriately changeable in accordance with the threshold set.

As illustrated in FIG. 3, upon determining in the step S20 that the R/B value is less than the predetermined threshold, the method involves performing the step S30 of increasing the flow rate of inert gas. In other words, when the oxygen level in the welding atmosphere is determined to be higher than the predetermined level in the step S20, the method involves performing the step S30 of increasing the flow rate of inert gas. The step S30 of increasing the flow rate of inert gas involves increasing the flow rate of inert gas to be injected by the injection mechanism 50. In this embodiment, the control device 60 acquires the result of the determining process performed by the image processing device 30 and exercises control to increase the flow rate of inert gas. In this embodiment, the control device 60 increases the flow rate of inert gas by controlling the flow control valve 53. The amount by which the flow rate of inert gas is to be increased is suitably set in accordance with, for example, welding condition(s) for the workpiece 5.

The following description discusses an experimental example in which the techniques disclosed herein were carried out. The following description, however, is not intended to limit the techniques disclosed herein to the experimental example below.

In the experimental example, two aluminum plate materials were prepared for use as a workpiece. In the experimental example, the two aluminum plate materials were laser welded. Laser welding was performed under the following conditions: a laser light wavelength of 1070 nm, a laser light beam diameter of 0.6 mm, a laser light output of 2000 W, and a welding speed of 200 mm/s. In the experimental example, images of welding light produced during laser welding were captured by an image capturing device while oxygen levels in a welding atmosphere were measured by an oxygen level sensor so as to measure RGB values of welding light. In the experimental example, the RGB values of welding light were measured when the oxygen levels in the welding atmosphere were 1.0%, 3.0%, 5.0%, 10.0%, and 20.7%.

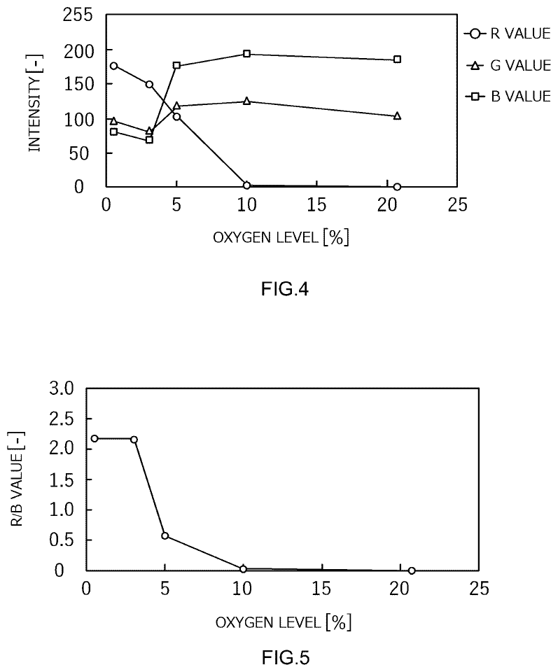

FIG. 4 is a graph illustrating the measurement results of the RGB values of welding light in the experimental example. The horizontal axis in the graph of FIG. 4 represents the oxygen levels in the welding atmosphere. The vertical axis in the graph of FIG. 4 represents the intensities of the R, G, and B values. The R, G, and B values are each represented in 256 levels from 0 to 255. As is clear from FIG. 4, as the oxygen level increases, the R value decreases and the B value increases. Accordingly, when the oxygen level is relatively high, the color of welding light is bluish. When the oxygen level is relatively low, the color of welding light is reddish.

FIG. 5 is a graph illustrating R/B value calculation results in the experimental example. The R/B values in the graph of FIG. 5 are calculated by dividing the R values (which are measured at the oxygen levels illustrated in FIG. 4) by the B values (which are measured at the oxygen levels illustrated in FIG. 4). The horizontal axis in the graph of FIG. 5 represents the oxygen levels in the welding atmosphere. The vertical axis in the graph of FIG. 5 represents the R/B values. As is clear from FIG. 5, the R/B value tends to decrease as the oxygen level increases. Accordingly, this demonstrates that there are correlations between the R/B values and the oxygen levels in the welding atmosphere, and thus the use of the R/B values enables monitoring of the oxygen levels in the welding atmosphere.

As illustrated in FIG. 3, the oxygen level monitoring method according to the above-described embodiment includes: the step S10 of measuring the color of welding light; and the step S20 of determining whether the oxygen level is less than or equal to the predetermined level. The findings of the inventors suggest a correlation between the color of welding light and the oxygen level in the welding atmosphere. Accordingly, this method is able to facilitate monitoring of the oxygen level in the welding atmosphere during welding of the workpiece 5.

In the above-described embodiment, the step S10 of measuring the color of welding light includes the image capturing step S11, the region selecting step S13, and the RGB measuring step S14. The image capturing step S11 involves capturing an image including welding light. The region selecting step S13 involves selecting, under a predetermined condition, a region representing welding light from the image captured. The RGB measuring step S14 involves measuring the RGB value of the region selected. This method is able to monitor the oxygen level by capturing the image during welding of the workpiece 5. Consequently, this method facilitates monitoring of the oxygen level.

In the above-described embodiment, the region selecting step S13 involves selecting, under the predetermined condition, two or more pixels representing welding light. The RGB measuring step S14 involves calculating the averages of the RGB values of the pixels selected. Because the averages of the RGB values of the pixels in the image captured are calculated, this method increases the accuracy of the RGB value measurement in the step S14.

In the above-described embodiment, the step S10 of measuring the color of welding light includes the R/B calculating step S15. The R/B calculating step S15 involves calculating an R/B value (which is the ratio of an R value to a B value) from each RGB value of welding light measured. The step S20 of determining whether the oxygen level is less than or equal to the predetermined level involves determining whether the R/B value calculated is greater than or equal to the predetermined threshold, thus determining whether the oxygen level in the welding atmosphere is less than or equal to the predetermined level. This, for example, enables a reduction in noise caused by external light, resulting in an improvement in oxygen level monitoring accuracy. As used herein, the term “external light” includes, for example, light emitted from lighting equipment installed in a space in which the workpiece 5 undergoes welding.

In the above-described embodiment, the oxygen level monitoring method includes the step S30 of increasing the flow rate of inert gas when the oxygen level in the welding atmosphere is determined to be higher than the predetermined level. This makes it possible to control the flow rate of inert gas, which is to be blown onto the workpiece 5, in accordance with an oxygen level monitoring result. Consequently, the above-described embodiment enables proper control of the oxygen level in the welding atmosphere during welding of the workpiece 5.

The first embodiment of the techniques disclosed herein has been described thus far. The embodiment described above, however, is provided by way of example only. Various other embodiments of the techniques disclosed herein are possible.

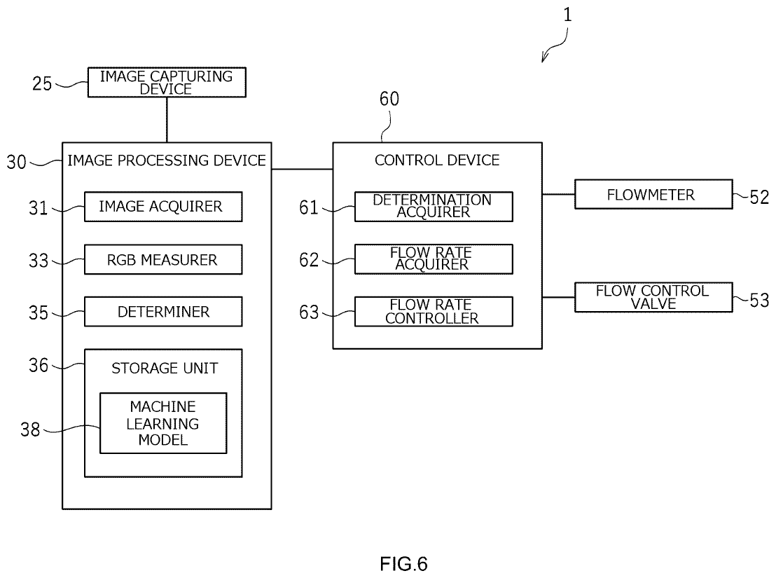

FIG. 6 is a block diagram of a welding system 1 according to a second embodiment of the techniques disclosed herein. In the mode illustrated in FIG. 6, a machine learning model 38 determines whether an oxygen level in a welding atmosphere is less than or equal to a predetermined level. In the mode illustrated in FIG. 6, an image processing device 30 includes an image acquirer 31, an RGB measurer 33, a determiner 35, and a storage unit 36. Similarly to the first embodiment described above, the image acquirer 31 performs an image acquiring process, the RGB measurer 33 performs an RGB measuring process, and the determiner 35 performs a determining process.

The storage unit 36 stores the machine learning model 38. The machine learning model 38 is a model pre-trained by machine learning. Various machine learning algorithms are applicable to the machine learning model 38. In one example, neural network algorithms are applied to the machine learning model 38. In the mode illustrated in FIG. 6, the machine learning model 38 is pre-trained by machining learning using, as training data, RGB value distributions in images including welding light and oxygen levels in welding atmospheres. As the machine learning model 38, a machine learning model generated in the image processing device 30 or generated by an external computer may be used.

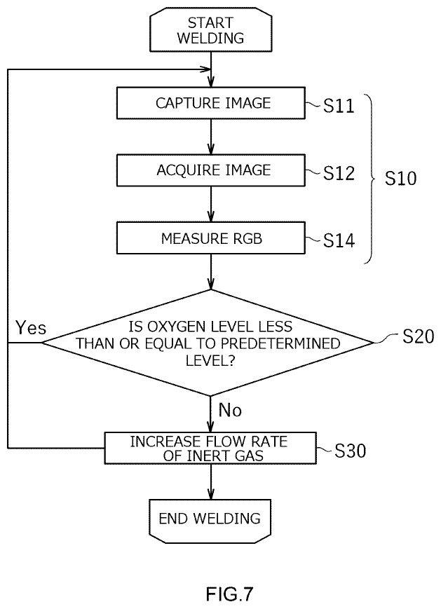

FIG. 7 is a flow chart illustrating an exemplary oxygen level monitoring method according to the second embodiment. The oxygen level monitoring method includes: a step S10 of measuring the color of welding light; a step S20 of determining whether the oxygen level is less than or equal to the predetermined level; and a step S30 of increasing the flow rate of inert gas. In the mode illustrated in FIG. 7, the step S10 of measuring the color of welding light includes an image capturing step S11, an image acquiring step S12, and an RGB measuring step S14.

In the mode illustrated in FIG. 7, the image capturing step S11 and the image acquiring step S12 are performed by following procedures similar to those described in relation to the mode illustrated in FIG. 3. In the mode illustrated in FIG. 7, the RGB measuring step S14 involves measuring an RGB value distribution in an image captured in the image capturing step S11. The RGB measuring step S14 may involve measuring the RGB value distribution throughout the image captured or may involve measuring the RGB value distribution in a specific region of the image captured. As used herein, the term “specific region” refers to a region including welding light. The specific region may be selected in any suitable manner. The specific region may be selected by, for example, the region selecting process performed in the region selecting step S13, which is described in relation to the mode illustrated in FIG. 3.

The step S20 of determining whether the oxygen level is less than or equal to the predetermined level involves performing the determining process. In the mode illustrated in FIG. 7, the step S20 involves inputting the measured RGB value distribution to the machine learning model 38, thus determining whether the oxygen level in the welding atmosphere is less than or equal to the predetermined level. In other words, in the mode illustrated in FIG. 7, the step S20 involves using the machine learning model 38 so as to determine whether the oxygen level in the welding atmosphere is less than or equal to the predetermined level from the measured RGB value distribution in the image.

The configuration of the injection mechanism 50 is not limited to that described in relation to the mode illustrated in FIG. 1. In one example, the injection mechanism 50 may include a mass flow controller instead of the flowmeter 52 and the flow control valve 53. Alternatively, the welding system 1 may include no injection mechanism 50. In this case, the step S30 of increasing the flow rate of inert gas is not performed.

In the first and second embodiments described above, the color of welding light is measured by capturing an image of welding light. The color of welding light, however, may be measured in any other suitable manner. In one example, the color of welding light may be measured by a device such as a photodiode-equipped color sensor.

In the mode illustrated in FIG. 3, the step S20 involves determining whether the oxygen level is less than or equal to the predetermined level by using an R/B value. The oxygen level, however, may be determined in any other suitable manner. In one example, the step S20 may involve determining whether an R value is greater than or equal to a predetermined threshold, thus determining whether the oxygen level is less than or equal to the predetermined level. The threshold for the R value may suitably be set, for example, in the range of 20 to 150. In another example, the step S20 may involve determining whether a B value is less than or equal to a predetermined threshold, thus determining whether the oxygen level is less than or equal to the predetermined level. The threshold for the B value may suitably be set, for example, in the range of 0 to 150.

The techniques disclosed herein have been described in various embodiments. Unless otherwise specified, the embodiments and examples mentioned herein do not limit the present invention. Various changes may be made to the techniques disclosed herein. Unless any particular problem arises, one or more of the components, elements, and processes mentioned herein may be omitted where appropriate, or any appropriate combination of the components, elements, and processes mentioned herein is possible. This specification includes the disclosure of items described below.

### Item 1

An oxygen level monitoring method for monitoring an oxygen level in a welding atmosphere during welding of a workpiece, the method including:
a step of measuring a color of welding light produced during welding of the workpiece; and
a step of determining whether the oxygen level in the welding atmosphere is less than or equal to a predetermined level in accordance with the measured color of the welding light.

### Item 2

The oxygen level monitoring method according to item 1, wherein
the step of measuring the color of the welding light includes
   a step of capturing an image including the welding light,
   a step of selecting, under a predetermined condition, a pixel representing the welding light from the image captured, and
   a step of measuring an RGB value of the pixel selected.

### Item 3

The oxygen level monitoring method according to item 2, wherein
in the step of selecting the pixel, the number of pixels selected under the predetermined condition is two or more, and
the step of measuring the RGB value involves calculating averages of the RGB values of the pixels selected.

### Item 4

The oxygen level monitoring method according to any one of items 1 to 3, wherein
the step of measuring the color of the welding light involves measuring an RGB value of the welding light, and calculating an R/B value from the measured RGB value of the welding light, where the R/B value is a ratio of an R value to a B value, and
the step of determining whether the oxygen level is less than or equal to the predetermined level involves determining whether the R/B value calculated is greater than or equal to a predetermined threshold, thus determining whether the oxygen level in the welding atmosphere is less than or equal to the predetermined level.

### Item 5

The oxygen level monitoring method according to item 1, wherein
the step of measuring the color of the welding light includes
   a step of capturing an image including the welding light, and
   a step of measuring an RGB value distribution in the image captured, and
the step of determining whether the oxygen level is less than or equal to the predetermined level involves using a machine learning model so as to determine whether the oxygen level in the welding atmosphere is less than or equal to the predetermined level from the measured RGB value distribution in the image, the machine learning model being pre-trained by machine learning using, as training data, an RGB value distribution in an image and an oxygen level in a welding atmosphere.

### Item 6

The oxygen level monitoring method according to any one of items 1 to 5, wherein
during welding of the workpiece, inert gas is blown onto the workpiece, and
the method further includes a step of increasing a flow rate of the inert gas when the oxygen level in the welding atmosphere is determined to be higher than the predetermined level.

### Item 7

An oxygen level monitoring apparatus for monitoring an oxygen level in a welding atmosphere during welding of a workpiece, the apparatus including:
an image capturing device to capture an image of welding light produced during welding of the workpiece; and
an image processing device to measure a color of the welding light from the image captured by the image capturing device, thus determining whether the oxygen level in the welding atmosphere is less than or equal to a predetermined level.

### Item 8

The oxygen level monitoring apparatus according to item 7, wherein
the image processing device is configured or programmed to perform
   a step of acquiring, from the image capturing device, the image captured by the image capturing device,
   a step of selecting, under a predetermined condition, a pixel representing the welding light from the image captured,
   a step of measuring an RGB value of the pixel selected, and
   a step of determining whether the oxygen level in the welding atmosphere is less than or equal to the predetermined level in accordance with the RGB value measured.

### Item 9

The oxygen level monitoring apparatus according to item 8, wherein
in the process of selecting the pixel, the number of pixels selected under the predetermined condition is two or more, and
the step of measuring the RGB value involves calculating averages of the RGB values of the pixels selected.

### Item 10

The oxygen level monitoring apparatus according to item 8 or 9, wherein
the image processing device is configured or programmed to further perform a process of calculating an R/B value from the RGB value measured, where the R/B value is a ratio of an R value to a B value, and
the process of determining whether the oxygen level is less than or equal to the predetermined level involves determining whether the R/B value calculated is greater than or equal to a predetermined threshold, thus determining whether the oxygen level in the welding atmosphere is less than or equal to the predetermined level.

### Item 11

The oxygen level monitoring apparatus according to item 7, wherein
the image processing device stores a machine learning model pre-trained by machine learning using, as training data, an RGB value distribution in an image and an oxygen level in a welding atmosphere, and
the image processing device is configured or programmed to perform
   a process of acquiring, from the image capturing device, the image captured by the image capturing device,
   a process of measuring an RGB value distribution in the image captured, and
   a process of inputting the measured RGB value distribution to the machine learning model, thus determining whether the oxygen level in the welding atmosphere is less than or equal to the predetermined level.

### Item 12

A welding system including:
a welding apparatus to weld a workpiece; and
the oxygen level monitoring apparatus according to any one of items 7 to 11.

### Item 13

The welding system according to item 12, the system further including:
an injection mechanism to blow inert gas onto the workpiece; and
a control device to control, in accordance with the determination of the oxygen level in the welding atmosphere made by the image processing device, a flow rate of the inert gas to be blown onto the workpiece by the injection mechanism.

What is claimed is:

1. An oxygen level monitoring method for monitoring an oxygen level in a welding atmosphere during welding of a workpiece, the method comprising:
a step of measuring a color of welding light produced during welding of the workpiece; and
a step of determining whether the oxygen level in the welding atmosphere is less than or equal to a predetermined level in accordance with the measured color of the welding light.

2. The oxygen level monitoring method according to claim 1, wherein
the step of measuring the color of the welding light includes
a step of capturing an image including the welding light,
a step of selecting, under a predetermined condition, a pixel representing the welding light from the image captured, and
a step of measuring an RGB value of the pixel selected.

3. The oxygen level monitoring method according to claim 2, wherein
in the step of selecting the pixel, the number of pixels selected under the predetermined condition is two or more, and
the step of measuring the RGB value involves calculating averages of the RGB values of the pixels selected.

4. The oxygen level monitoring method according to claim 1, wherein
the step of measuring the color of the welding light involves measuring an RGB value of the welding light, and calculating an R/B value from the measured RGB value of the welding light, where the R/B value is a ratio of an R value to a B value, and
the step of determining whether the oxygen level is less than or equal to the predetermined level involves determining whether the R/B value calculated is greater than or equal to a predetermined threshold, thus determining whether the oxygen level in the welding atmosphere is less than or equal to the predetermined level.

5. The oxygen level monitoring method according to claim 1, wherein
the step of measuring the color of the welding light includes
a step of capturing an image including the welding light, and
a step of measuring an RGB value distribution in the image captured, and
the step of determining whether the oxygen level is less than or equal to the predetermined level involves using a machine learning model so as to determine whether the oxygen level in the welding atmosphere is less than or equal to the predetermined level from the measured RGB value distribution in the image, the machine learning model being pre-trained by machine learning using, as training data, an RGB value distribution in an image and an oxygen level in a welding atmosphere.

6. The oxygen level monitoring method according to claim 1, wherein
during welding of the workpiece, inert gas is blown onto the workpiece, and
the method further comprises a step of increasing a flow rate of the inert gas when the oxygen level in the welding atmosphere is determined to be higher than the predetermined level.

7. An oxygen level monitoring apparatus for monitoring an oxygen level in a welding atmosphere during welding of a workpiece, the apparatus comprising:
an image capturing device to capture an image of welding light produced during welding of the workpiece; and
an image processing device to measure a color of the welding light from the image captured by the image capturing device, thus determining whether the oxygen level in the welding atmosphere is less than or equal to a predetermined level.

8. The oxygen level monitoring apparatus according to claim 7, wherein
the image processing device is configured or programmed to perform
a step of acquiring, from the image capturing device, the image captured by the image capturing device,
a step of selecting, under a predetermined condition, a pixel representing the welding light from the image captured,
a step of measuring an RGB value of the pixel selected, and
a step of determining whether the oxygen level in the welding atmosphere is less than or equal to the predetermined level in accordance with the RGB value measured.

9. The oxygen level monitoring apparatus according to claim 8, wherein
in the process of selecting the pixel, the number of pixels selected under the predetermined condition is two or more, and
the step of measuring the RGB value involves calculating averages of the RGB values of the pixels selected.

10. The oxygen level monitoring apparatus according to claim 8, wherein
the image processing device is configured or programmed to further perform a process of calculating an R/B value from the RGB value measured, where the R/B value is a ratio of an R value to a B value, and
the process of determining whether the oxygen level is less than or equal to the predetermined level involves determining whether the R/B value calculated is greater than or equal to a predetermined threshold, thus determining whether the oxygen level in the welding atmosphere is less than or equal to the predetermined level.

11. The oxygen level monitoring apparatus according to claim 7, wherein
the image processing device stores a machine learning model pre-trained by machine learning using, as training data, an RGB value distribution in an image and an oxygen level in a welding atmosphere, and
the image processing device is configured or programmed to perform
a process of acquiring, from the image capturing device, the image captured by the image capturing device,
a process of measuring an RGB value distribution in the image captured, and
a process of inputting the measured RGB value distribution to the machine learning model, thus determining whether the oxygen level in the welding atmosphere is less than or equal to the predetermined level.

12. A welding system comprising:
a welding apparatus to weld a workpiece; and
the oxygen level monitoring apparatus according to claim 7.

13. The welding system according to claim 12, further comprising:
an injection mechanism to blow inert gas onto the workpiece; and
a control device to control, in accordance with the determination of the oxygen level in the welding atmosphere made by the image processing device, a flow rate of the inert gas to be blown onto the workpiece by the injection mechanism.
